(19) United States
(12) Patent Application Publication
(10) Pub. No.: US 2026/0051602 A1
(43) Pub. Date: Feb. 19, 2026

(54) BATTERY MODULE AND MANUFACTURING METHOD OF BATTERY MODULE

(71) Applicant: HYUNDAI MOBIS CO., LTD., Seoul (KR)

(72) Inventor: Young Chan YOON, Yongin-si (KR)

(73) Assignee: HYUNDAI MOBIS CO., LTD., Seoul (KR)

(21) Appl. No.: 19/298,535

(22) Filed: Aug. 13, 2025

(30) Foreign Application Priority Data
Aug. 16, 2024 (KR) 10-2024-0110057

(51) Int. Cl. H01M 50/264; H01M 10/04

(52) U.S. Cl. CPC H01M 50/264; H01M 10/0481

(57) ABSTRACT

A battery module includes battery cells stacked in a first direction, a pair of end plates disposed on opposite sides of the battery cells in the first direction, and a support strap that presses the pair of end plates inward from outside the pair of end plates in the first direction. The support strap includes a first support strap including a portion disposed on one side of the battery cells in a second direction crossing the first direction and a second support strap including a portion disposed on an opposite side of the battery cells in the second direction, and the first support strap and the second support strap are alternately arranged along the end plates in a third direction crossing the first direction and the second direction.

### CROSS-REFERENCE TO RELATED APPLICATION

This application claims the benefit of priority to Korean Patent Application No. 10-2024-0110057, filed in the Korean Intellectual Property Office on Aug. 16, 2024, the entire contents of which are incorporated herein by reference.

### TECHNICAL FIELD

The present disclosure relates to a battery module and a method for manufacturing the battery module.

### BACKGROUND

In recent years, research and development on environmentally-friendly mobility including environmentally-friendly vehicles and environmentally-friendly air mobility has been emphasized as crisis awareness of environments and oil resource depletion has increased.

Environmentally-friendly mobility may be equipped with a battery module including battery cells as a driving source. The battery module may include the battery cells and end plates supporting the battery cells.

Meanwhile, the weight of the battery module mounted in the environmentally-friendly mobility may affect the driving distance of the environmentally-friendly mobility, and therefore there is an increasing demand for weight reduction of the battery module.

### SUMMARY

The present disclosure has been made to solve the above-mentioned problems occurring in the prior art while advantages achieved by the prior art are maintained intact.

An aspect of the present disclosure provides a lightweight battery module with rigidity secured.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery module includes battery cells stacked in a first direction, a pair of end plates disposed on opposite sides of the battery cells in the first direction, and a support strap that presses the pair of end plates inward from outside the pair of end plates in the first direction. The support strap includes a first support strap including a portion disposed on one side of the battery cells in a second direction crossing the first direction and a second support strap including a portion disposed on an opposite side of the battery cells in the second direction, and the first support strap and the second support strap are alternately arranged along the end plates in a third direction crossing the first direction and the second direction.

The support strap may include a pair of plate support areas that extend in the second direction and that are brought into contact with the pair of end plates, respectively, and a side area that connects the pair of plate support areas and extends in the first direction.

Each of the end plates may include a strap groove into which the support strap is inserted, and the strap groove may extend in the second direction.

A width of the strap groove in the third direction may correspond to a width of the support strap in the third direction.

The end plate may further include a protruding rib that is disposed in the third direction with respect to the strap groove and that protrudes outward in the first direction.

The protruding rib may extend in the second direction.

In an area where the support strap faces the end plate, the protruding rib may protrude outward in the first direction with respect to the support strap.

The support strap may include a pair of plate support areas that extend in the second direction and that are brought into contact with the pair of end plates, respectively, and a side area that connects the pair of plate support areas and extends in the first direction, and the strap groove may include a plate groove area into which the plate support area is inserted and a side groove area into which the side area is inserted and that is disposed on a side surface of the end plate that faces in the second direction.

Each of the plate support areas may include one end portion connected with the side area and an opposite end portion disposed on an opposite side to the one end portion, and the opposite end portion of the plate support area may be coupled with the end plate.

Both the one end portion and the opposite end portion of the plate support area may be coupled with the end plate.

A length of each of the plate support areas in the second direction may correspond to a length of the end plate in the second direction or may be greater than half of the length of the end plate in the second direction and smaller than the length of the end plate in the second direction.

According to another aspect of the present disclosure, a battery module includes battery cells stacked in a first direction, a pair of end plates disposed on opposite sides of the battery cells in the first direction, and a support strap that presses the pair of end plates inward from outside the pair of end plates in the first direction. The support strap includes a pair of plate support areas that are disposed outside the pair of end plates in the first direction and that extend in a second direction crossing the first direction and a side area that connects the pair of plate support areas and extends in the first direction.

Each of the end plates may include a strap groove that is disposed on an outside of the end plate in the first direction and into which the support strap is inserted.

The strap groove may extend in the second direction, and a width of the strap groove in a third direction crossing the first direction and the second direction may correspond to a width of the support strap in the third direction.

The end plate may further include a protruding rib that is disposed on one side of the strap groove in a third direction crossing the first direction and the second direction and that protrudes outward in the first direction.

According to another aspect of the present disclosure, a method for manufacturing a battery module includes a cell stacking step of stacking battery cells in a first direction, a side plate placing step of placing a pair of side plates on opposite sides of the battery cells in a second direction crossing the first direction, an end plate placing step of placing a pair of end plates on opposite sides of the battery cells in the first direction, a pressing step of pressing the end plates using a pressing jig, and a strap inserting step of inserting, through between the pressing jig and the end plates, a support strap that supports the end plates.

The strap inserting step may include inserting the support strap from one side of the end plates in the second direction.

The support strap may include a first support strap including a portion disposed on one side of the battery cells in the second direction and a second support strap including a portion disposed on an opposite side of the battery cells in the second direction, and the strap inserting step may include inserting the first support strap from one side toward an opposite side of the end plates in the second direction and inserting the second support strap from the opposite side toward the one side of the end plates in the second direction.

The strap inserting step may further include alternately arranging the first support strap and the second support strap along the end plates in a third direction crossing the first direction and the second direction.

Each of the end plates may include a strap groove that is disposed on an outside of the end plate in the first direction and that extends in the second direction, and the strap inserting step may include inserting the support strap into the strap groove.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of battery cells, side plates, end plates, and a support strap of a battery module according to an embodiment of the present disclosure;

FIG. 2 is an exploded perspective view of the battery cells, the side plates, the end plates, and the support strap of the battery module according to an embodiment of the present disclosure;

FIG. 3 is an enlarged view of portion A illustrated in FIG. 2;

FIG. 4 is a view illustrating the distribution of stress applied to the end plates according to an embodiment of the present disclosure;

FIG. 5 is a perspective view of battery cells, side plates, end plates, and a support strap of a battery module according to another embodiment of the present disclosure;

FIG. 6 is a flowchart illustrating a method for manufacturing a battery module according to an embodiment of the present disclosure;

FIGS. 7 and 8 are views of the battery module and a pressing jig in a pressing step according to an embodiment of the present disclosure; and

FIG. 9 is a view of the battery module and the pressing jig in a strap inserting step according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In this specification, a first direction D1, a second direction D2, and a third direction D3 may be directions perpendicular to one another.

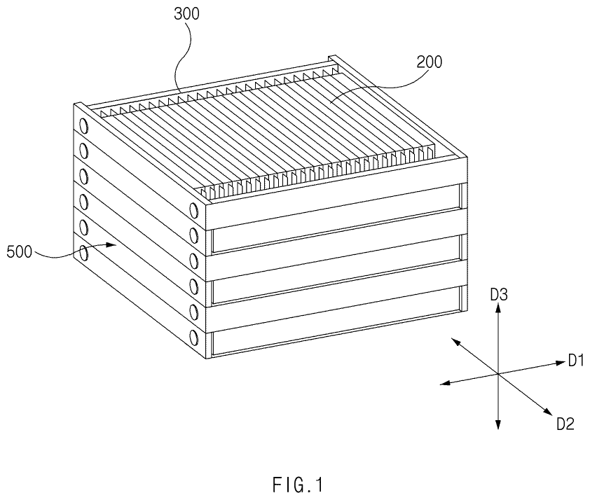

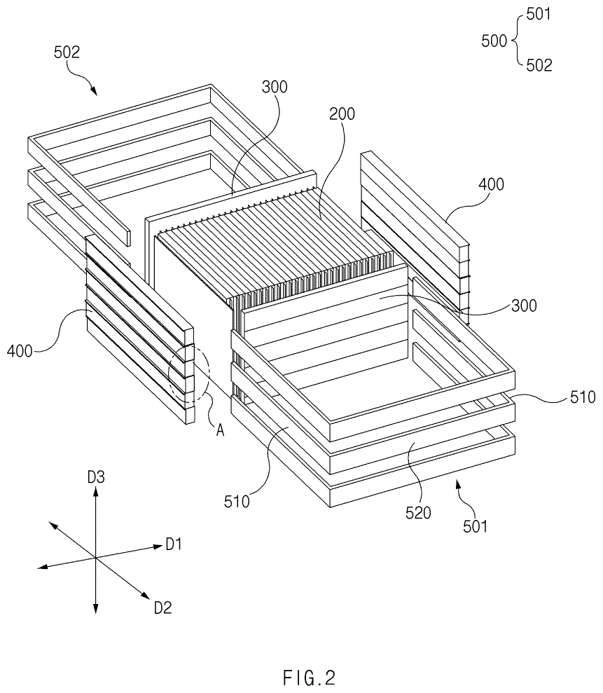

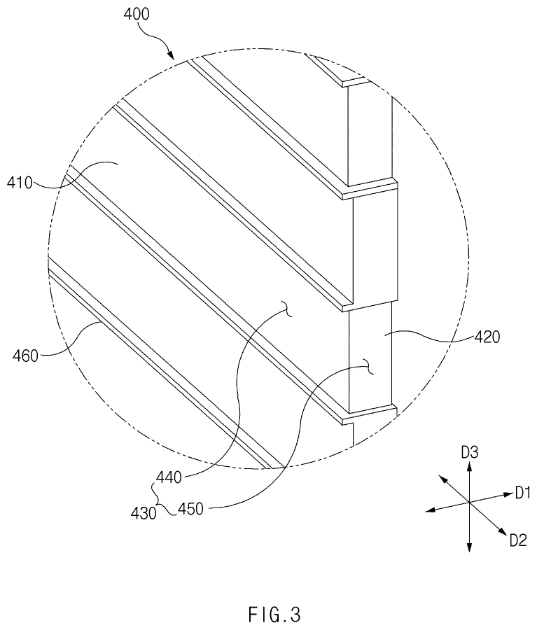

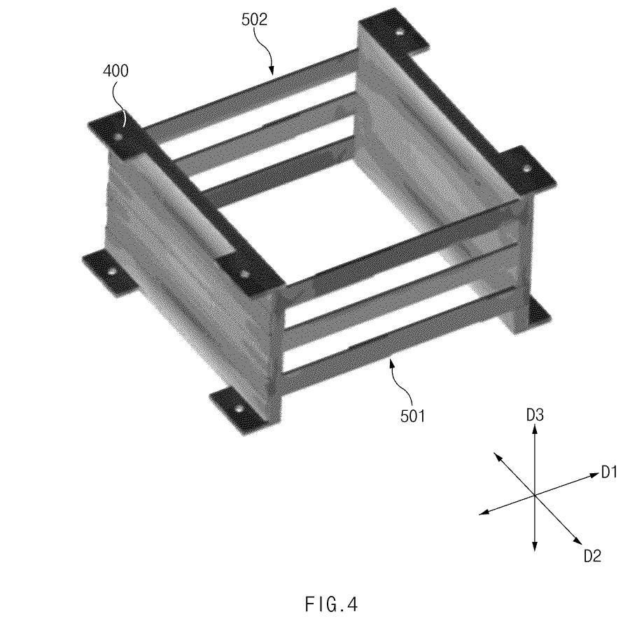

FIG. 1 is a perspective view of battery cells, side plates, end plates, and a support strap of a battery module according to an embodiment of the present disclosure. FIG. 2 is an exploded perspective view of the battery cells, the side plates, the end plates, and the support strap of the battery module according to an embodiment of the present disclosure. FIG. 3 is an enlarged view of portion A illustrated in FIG. 2. FIG. 4 is a view illustrating the distribution of stress applied to the end plates according to an embodiment of the present disclosure.

Referring to FIGS. 1 to 4, the battery module 100 may be mounted in environmentally-friendly mobility. The battery module 100 may include the battery cells 200 stacked in the first direction D1, a pair of side plates 300 disposed on opposite sides of the battery cells 200 in the second direction D2, and a pair of end plates 400 disposed on opposite sides of the battery cells 200 in the first direction D1.

The battery module 100 may include the support strap 500 formed to surround one of the pair of side plates 300 while surrounding the pair of end plates 400.

The support strap 500 may be formed to press the pair of end plates 400 inward from outside the pair of end plates 400 in the first direction D1. By pressing the pair of end plates 400 inward in the first direction D1, the support strap 500 may prevent the battery cells 200 from swelling in the first direction D1.

The support strap 500 may include a first support strap 501 including a portion disposed on one side of the battery cells 200 in the second direction D2 and a second support strap 502 including a portion disposed on the opposite side of the battery cells 200 in the second direction D2.

At least two first support straps 501 and at least two second support straps 502 may be provided. The at least two first support straps 501 and the at least second support straps 502 may be alternately arranged along the end plates 400 in the third direction D3.

Each of the first support straps 501 and the second support straps 502 may include a pair of plate support areas 510 that extend in the second direction D2 and that are brought into contact with the pair of end plates 400, respectively, and a side area 520 that connects the pair of plate support areas 510 and extends in the first direction D1.

The pair of plate support areas 510 may be disposed outside the pair of end plates 400 in the first direction D1 and may extend parallel to each other. The pair of plate support areas 510 may be brought into contact with the pair of end plates 400, respectively.

The side area 520 may be brought into contact with the side plate 300. As described above, the first support straps 501 and the second support straps 502 may be disposed on the opposite sides of the battery cells 200 in the second direction D2 to surround the battery cells 200, the side plates 300, and the end plates 400.

Each of the end plates 400 may include a strap groove 430 for the support strap 500 inserted into the end plate 400 in the second direction D2. The strap groove 430 may be formed on the outside of the end plate 400 that faces in the first direction D1. The strap groove 430, into which the support strap 500 is inserted, may extend in the second direction D2 to guide the support strap 500. The width of the strap groove 430 in the third direction D3 may correspond to the width of the support strap 500 in the third direction D3.

The strap groove 430 may be provided6 in plural in correspondence with the sum of the number of first support straps 501 and the number of second support straps 502. The strap grooves 430 may be arranged in the third direction D3 so as to be spaced apart from one another.

Each of the strap grooves 430 may include a plate groove area 440 into which the plate support area 510 is inserted and a side groove area 450 into which the side area 520 is inserted.

In more detail, the end plate 400 may include an outer surface 410 facing outward in the first direction D1 and a side surface 420 facing outward in the second direction D2.

The plate groove area 440 may be formed on the outer surface 410 of the end plate 400, and the side groove area 450 may be formed on the side surface 420 of the end plate 400.

The side groove areas 450 of the strap grooves 430 into which the first support traps 501 are inserted among the plurality of strap grooves 430 may be disposed on one side of the plate groove areas 440 in the second direction D2.

In addition, the side groove areas 450 of the strap grooves 430 into which the second support traps 502 are inserted among the plurality of strap grooves 430 may be disposed on an opposite side of the plate groove areas 440 in the second direction D2.

The end plate 400 may include protruding ribs 460 that are disposed between the plurality of strap grooves 430 and that protrude outward in the first direction D1. The protruding ribs 460 may be disposed in the third direction D3 with respect to the strap grooves 430 and may extend in the second direction D2. In other words, the plate groove areas 440 may be defined by the protruding ribs 460.

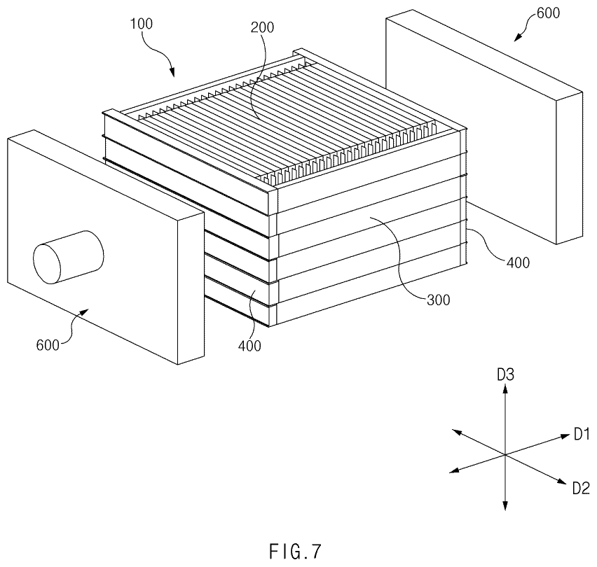

In the area where the support strap 500 faces the end plate 400, the protruding ribs 460 may protrude outward in the first direction D1 when compared to the support strap 500. This may be for contact with a pressing jig 600 (refer to FIG. 7) to be described below.

The first support straps 501 and the second support straps 502 may be inserted from opposite sides of the end plate 400 in the second direction D2 through the strap grooves 430.

According to this structure, the positions of the first support straps 501 and the second support straps 502 may be guided in a process of manufacturing the battery module 100, and thus the manufacturability of the battery module 100 may be improved.

The plate support area 510 may be supported by a pair of protruding ribs 460 spaced apart from each other in the third direction D3. The plate support area 510 may include one end portion connected with the side area 520 and an opposite end portion disposed on the opposite side to the one end portion. The one end portion and the opposite end portion of the plate support area 510 may be disposed parallel to each other in the second direction D2.

Both the one end portion and the opposite end portion of the plate support area 510 may be coupled to the end plate 400. That is, each of the first support straps 501 and the second support straps 502 may be fixed to the pair of end plates 400 through four areas. In this case, the length of the plate support area 510 in the second direction D2 may correspond to the length of the end plate 400 in the second direction D2.

According to this structure, as illustrated in FIG. 4, the stress applied to the end plate 400 may be relatively uniformly distributed in the second direction D2. That is, as compared with when stress is applied to a local area of an end plate, the rigidity of the end plate 400 of the present disclosure may be improved, and thus the durability of the battery module 100 may be improved.

Meanwhile, the support strap 500 may be formed of a composite material, but is not limited thereto. For example, the support strap 500 may be formed of carbon fiber reinforced plastic (CFRP) or glass fiber reinforced plastic (GFRP).

The support strap 500 may be formed of a material having a density lower than the density of steel and the density of aluminum. In addition, the support strap 500 may be formed of a material having yield strength higher than the yield strength of steel and the yield strength of aluminum.

Because the support strap 500 is formed of the above-described material, the battery module 100 may prevent the support strap 500 from being damaged due to swelling of the battery cells 200, while satisfying operating conditions of the environmentally-friendly mobility that require relatively high output. Thus, the durability of the battery module 100 may be improved.

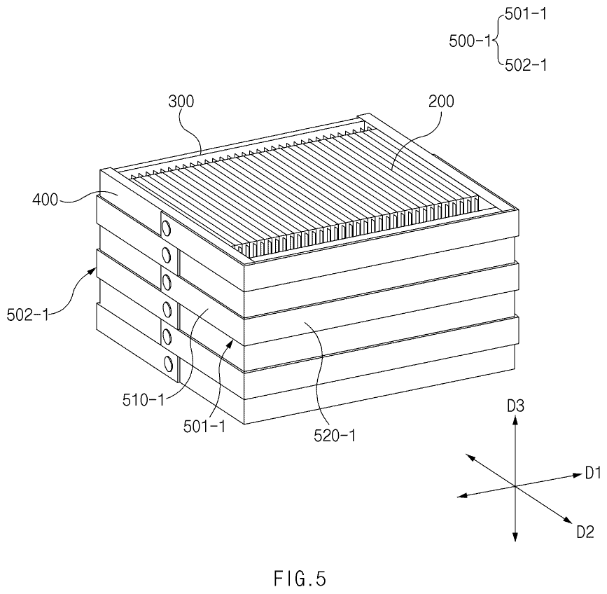

FIG. 5 is a perspective view of battery cells, side plates, end plates, and a support strap of a battery module according to another embodiment of the present disclosure.

Referring to FIG. 5, the shape of the support trap 500-1 may be different from the shape of the support strap 500 of the battery module 100 illustrated in FIG. 1.

The support strap 500-1 may include first support straps 501-1 including a portion disposed on one side of the battery cells 200 in the second direction D2 and second support straps 502-1 including a portion disposed on an opposite side of the battery cells 200 in the second direction D2.

Each of the first support straps 501-1 and the second support straps 502-1 may include a pair of plate support areas 510-1 and a side area 520-1 connecting the pair of plate support areas 510-1.

The length of the plate support areas 510-1 in the second direction D2 may be greater than half of the length of the end plates 400 in the second direction D2 and smaller than the length of the end plates 400 in the second direction D2. For example, the length of the plate support areas 510 in the second direction D2 may be 60% of the length of the end plates 400 in the second direction D2.

According to this structure, an opposite end portion of each plate support area 510-1 disposed on the opposite side to one end portion of the plate support area 510-1 connected with the side area 520-1 may be coupled with the end plate 400. Because the length of the plate support area 510-1 in the second direction D2 is smaller than the length of the end plate 400 in the second direction D2 unlike in FIG. 1, only the opposite end portion of the plate support area 510-1 may be coupled with the end plate 400.

The purposes of the battery cells 200, the side plates 300, the end plates 400, the plate support areas 510-1, and the side area 520-1 except for the shape of the support strap 500-1 illustrated in FIG. 5 refer to the description of FIG. 1.

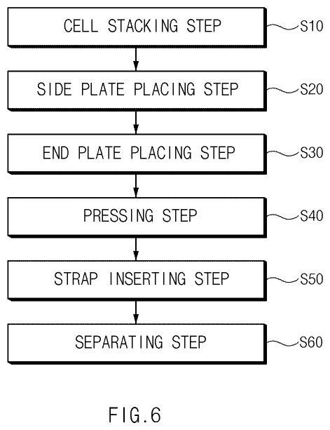

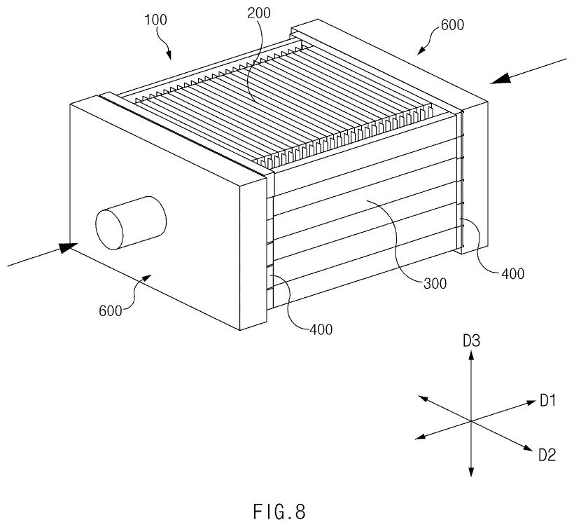

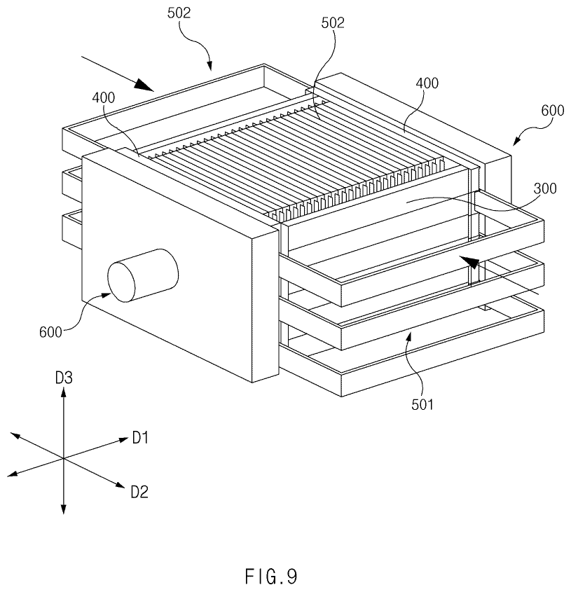

FIG. 6 is a flowchart illustrating a method for manufacturing a battery module according to an embodiment of the present disclosure. FIGS. 7 and 8 are views of the battery module and the pressing jig in a pressing step according to an embodiment of the present disclosure. FIG. 9 is a view of the battery module and the pressing jig in a strap inserting step according to an embodiment of the present disclosure.

Referring to FIGS. 6 to 9, the method for manufacturing the battery module 100 may include a cell stacking step S10, a side plate placing step S20, an end plate placing step S30, a pressing step S40, a strap inserting step S50, and a separating step S60.

The cell stacking step S10 may be a step of stacking the battery cells 200 in the first direction D1.

The side plate placing step S20 may be a step of placing the pair of side plates 300 on the opposite sides of the battery cells 200 in the second direction D2.

The side plate placing step S20 may be performed after the cell stacking step S10. However, the cell stacking step S10 may be performed after the side plate placing step S20. For example, the battery cells 200 may be stacked in the first direction D1 between the pair of side plates 300.

The end plate placing step S30 may be a step of placing the pair of end plates 400 on the opposite sides of the battery cells 200 in the first direction D1.

The end plate placing step S30 may be performed after the side plate placing step S20. However, the side plate placing step S20 may be performed after the end plate placing step S30.

The pressing step S40 may be a step of pressing the pair of end plates 400 using the pressing jig 600 as illustrated in FIGS. 7 and 8 after the end plate placing step S30. In the pressing step S40, a pair of pressing jigs 600 may press the pair of end plates 400, respectively. However, the present disclosure is not limited thereto.

In more detail, after the battery cells 200 are surrounded by the pair of side plates 300 and the pair of end plates 400, the pair of pressing jigs 600 may be moved toward the pair of end plates 400, respectively, in the pressing step S40.

In the pressing step S40, the pair of pressing jigs 600 may press the pair of end plates 400 inward in the first direction D1. At this time, the pair of pressing jigs 600 may be brought into contact with the protruding ribs 460 (refer to FIG. 3) of the end plates 400.

The strap inserting step S50 may be a step of inserting the support strap 500 through between the pressing jigs 600 and the end plates 400 as illustrated in FIG. 9 after the pressing step S40. The support strap 500 may be a component for supporting the end plates 400.

The strap inserting step S50 may include inserting the support strap 500 in the second direction D2 from one side of the end plates 400.

In more detail, the strap inserting step S50 may include inserting the first support straps 501 from the one side toward the opposite side of the end plates 400 in the second direction D2 and inserting the second support straps 502 from the opposite side toward the one side of the end plates 400 in the second direction D2.

The strap inserting step S50 may include inserting the support strap 500 into the strap grooves 430 that are spaces between the pressing jigs 600 and the end plates 400. In more detail, in the strap inserting step S50, the first support straps 501 and the second support straps 502 may be inserted through the opposite sides of the strap grooves 430 in the second direction D2.

The strap inserting step S50 may include alternately arranging the first support straps 501 and the second support straps 502 along the end plates 400 in the third direction D3.

The strap inserting step S50 may include coupling the end plates 400 and the support strap 500. In the strap inserting step S50, the pressure of the pressing jigs 600 applied to the end plates 400 may be maintained.

The separating step S60 may be a step of separating the pressing jigs 600 from the end plates 400 after the strap inserting step S50.

According to the manufacturing method of the battery module 100 described above, the first support straps 501 and the second support straps 502 may support the end plates 400, thereby preventing a swelling phenomenon of the battery cells 200.

In addition, the positions of the first support straps 501 and the second support straps 502 may be guided so that the manufacturing process of the battery module 100 may be simplified, and thus the productivity of the battery module 100 may be improved.

According to the present disclosure, the weight of the battery module may be reduced, and thus the driving distance of the environmentally-friendly mobility may be improved.

Furthermore, according to the present disclosure, the stress applied to the end plates of the battery module may be distributed, and thus the durability of the battery module may be improved.

Moreover, according to the present disclosure, the first support straps and the second support straps of the battery module may be alternately arranged to support the end plates. Accordingly, deformation of the end plates by the battery cells may be prevented, and thus the durability of the battery module may be improved.

In addition, according to the present disclosure, the positions of the support straps may be guided by the strap grooves of the end plates, and thus the manufacturability of the battery module may be improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A battery module comprising:
battery cells stacked in a first direction;
a pair of end plates disposed on opposite sides of the battery cells in the first direction; and
a support strap configured to press the pair of end plates inward from outside the pair of end plates in the first direction,
wherein the support strap includes:
a first support strap including a portion disposed on one side of the battery cells in a second direction crossing the first direction; and
a second support strap including a portion disposed on an opposite side of the battery cells in the second direction,
wherein the first support strap and the second support strap are alternately arranged along the end plates in a third direction crossing the first direction and the second direction.

2. The battery module of claim 1, wherein the support strap includes:
a pair of plate support areas configured to extend in the second direction and brought into contact with the pair of end plates, respectively; and
a side area configured to connect the pair of plate support areas and extend in the first direction.

3. The battery module of claim 1, wherein each of the end plates includes a strap groove into which the support strap is inserted, and the strap groove extends in the second direction.

4. The battery module of claim 3, wherein a width of the strap groove in the third direction corresponds to a width of the support strap in the third direction.

5. The battery module of claim 4, wherein each of the end plates includes a protruding rib disposed in the third direction with respect to the strap groove and configured to protrude outward in the first direction.

6. The battery module of claim 5, wherein the protruding rib extends in the second direction.

7. The battery module of claim 5, wherein in an area where the support strap faces the end plate, the protruding rib protrudes outward in the first direction with respect to the support strap.

8. The battery module of claim 3, wherein the support strap includes:
a pair of plate support areas configured to extend in the second direction and brought into contact with the pair of end plates, respectively; and
a side area configured to connect the pair of plate support areas and extend in the first direction, and
wherein the strap groove includes:
a plate groove area into which the plate support area is inserted; and
a side groove area into which the side area is inserted, the side groove area being disposed on a side surface of the end plate configured to face in the second direction.

9. The battery module of claim 2, wherein each of the plate support areas includes one end portion connected with the side area and an opposite end portion disposed on an opposite side to the one end portion, and
wherein the opposite end portion of the plate support area is coupled with the end plate.

10. The battery module of claim 9, wherein both the one end portion and the opposite end portion of the plate support area are coupled with the end plate.

11. The battery module of claim 2, wherein a length of each of the plate support areas in the second direction corresponds to a length of the end plate in the second direction or is greater than half of the length of the end plate in the second direction and smaller than the length of the end plate in the second direction.

12. A battery module comprising:
battery cells stacked in a first direction;
a pair of end plates disposed on opposite sides of the battery cells in the first direction; and
a support strap configured to press the pair of end plates inward from outside the pair of end plates in the first direction,
wherein the support strap includes:
a pair of plate support areas disposed outside the pair of end plates in the first direction and configured to extend in a second direction crossing the first direction; and
a side area configured to connect the pair of plate support areas and extend in the first direction.

13. The battery module of claim 12, wherein each of the end plates includes a strap groove into which the support strap is inserted, and the strap groove is disposed on an outside of the end plate in the first direction.

14. The battery module of claim 13, wherein the strap groove extends in the second direction, and
wherein a width of the strap groove in a third direction crossing the first direction and the second direction corresponds to a width of the support strap in the third direction.

15. The battery module of claim 13, wherein each of the end plates includes a protruding rib disposed on one side of the strap groove in a third direction crossing the first direction and the second direction and configured to protrude outward in the first direction.

16. A method for manufacturing a battery module, the method comprising:
a cell stacking step of stacking battery cells in a first direction;
a side plate placing step of placing a pair of side plates on opposite sides of the battery cells in a second direction crossing the first direction;
an end plate placing step of placing a pair of end plates on opposite sides of the battery cells in the first direction;
a pressing step of pressing the end plates using a pressing jig; and
a strap inserting step of inserting, between the pressing jig and the end plates, a support strap configured to support the end plates.

17. The method of claim 16, wherein the strap inserting step includes inserting the support strap from one side of the end plates in the second direction.

18. The method of claim 16, wherein the support strap includes a first support strap including a portion disposed on one side of the battery cells in the second direction and a second support strap including a portion disposed on an opposite side of the battery cells in the second direction, and
wherein the strap inserting step includes:
inserting the first support strap from one side toward an opposite side of the end plates in the second direction; and
inserting the second support strap from the opposite side toward the one side of the end plates in the second direction.

19. The method of claim 18, wherein the strap inserting step includes alternately arranging the first support strap and the second support strap along the end plates in a third direction crossing the first direction and the second direction.

20. The method of claim 16, wherein each of the end plates includes a strap groove disposed on an outside of the end plate in the first direction and configured to extend in the second direction, and
wherein the strap inserting step includes inserting the support strap into the strap groove.
